(19) United States
(12) Patent Application Publication
(10) Pub. No.: US 2004/0181983 A1
(43) Pub. Date: Sep. 23, 2004

(54) Flame simulating assembly

(75) Inventors: Kristoffer Hess, Cambridge (CA); Kelly Stinson, Kitchener (CA)

Correspondence Address: VALENTINE A. COTTRILL, SUITE 1020 50 QUEEN STREET NORTH, KITCHENER, ON, N2H6M2, CA

(73) Assignee: Dimplex North America Limited, Cambridge (CA)

(21) Appl. No.: 10/799,611

(22) Filed: Mar. 15, 2004

Related U.S. Application Data
(63) Continuation-in-part of application No. 10/101,013, filed on Mar. 20, 2002, now Pat. No. 6,718,665.
Application No. 10/101,013 is a continuation-in-part of application No. 09/443,324, filed on Nov. 19, 1999, now Pat. No. 6,363,636.
Application No. 09/443,324 is a division of application No. 08/868,948, filed on Jun. 4, 1997, now Pat. No. 6,050,011.
Application No. 08/868,948 is a continuation-in-part of application No. 08/649,510, filed on May 17, 1996, now Pat. No. 5,642,580.

(51) Int. Cl. G09F 19/00

(52) U.S. Cl. 40/428

(57) ABSTRACT

A flame simulating assembly for providing a three-dimensional image of flames formed by fluctuating light. The flame simulating assembly has a simulated fuel bed, a light source, and a screen disposed behind the simulated fuel bed for diffusing and transmitting light. The screen includes a conoid concavity positioned adjacent to the simulated fuel bed. The flame simulating assembly also includes a flicker element for creating the fluctuating light, the flicker element being positioned in a path of light between the light source and the screen. The fluctuating light is transmitted through the screen and attenuated to form the three-dimensional image of flames.

This is a continuation-in-part application of application Ser. No. 10/101,013, filed Mar. 20, 2002, which was a continuation-in-part application of application Ser. No. 09/443,324, filed Nov. 19, 1999, now U.S. Pat. No. 6,363,636, which was a divisional application of application Ser. No. 08/868,948, filed Jun. 4, 1997, now U.S. Pat. No. 6,050,011, which was a continuation-in-part application of application Ser. No. 08/649,510, filed May 17, 1996, now U.S. Pat. No. 5,642,580.

### FIELD OF THE INVENTION

The present invention relates generally to simulated fireplaces and, more particularly, to flame simulating assemblies for electric fireplaces and the like.

### BACKGROUND OF THE INVENTION

Electric fireplaces are popular because they provide visual qualities similar to those of real fireplaces without the costs and complications associated with venting of combustion gases. An assembly for producing a realistic simulated flame for electric fireplaces is disclosed in U.S. Pat. No. 4,965,707 (Butterfield). In the Butterfield patent, an assembly is disclosed in which billowing ribbons and a diffusion screen are used for simulating flames. The simulated flames are surprisingly realistic, although the effect resembles a flame from a coal fuel source rather than a wooden log fuel source.

There is a need for an assembly for producing simulated flames that more realistically resembles flames from burning fuel.

### SUMMARY OF THE INVENTION

In a broad aspect of the present invention, there is provided a flame simulating assembly for providing a three-dimensional image of flames formed by fluctuating light. The flame simulating assembly has a simulated fuel bed, a light source, and a screen disposed behind the simulated fuel bed for diffusing and transmitting light. The screen includes a conoid concavity positioned adjacent to the simulated fuel bed. The flame simulating assembly also includes a flicker element for creating the fluctuating light. The flicker element is positioned in a path of light between the light source and the screen. The fluctuating light is transmitted through the screen and attenuated to form the three-dimensional image of flames.

In another aspect, the conoid concavity includes a plurality of grooves, for further attenuating the fluctuating light transmitted through the conoid concavity, to form the three-dimensional image of flames.

In yet another aspect, the flame simulating assembly additionally includes a flame effect element positioned in a path of the fluctuating light between the flicker element and the screen, to configure the fluctuating light to form the image of flames.

In another of its aspects, the invention provides a flame simulating assembly for providing a three-dimensional image of flames formed by fluctuating light. The flame simulating assembly has a simulated fuel bed, a light source, and a screen including a front member disposed behind the simulated fuel bed and a diffusing member disposed behind the front member for diffusing and transmitting light. The front member has a partially reflective front surface for reflecting and transmitting light and the diffusing member has a conoid concavity positioned proximal to the simulated fuel bed. The flame simulating assembly also includes a flicker element for creating the fluctuating light. The flicker element is positioned in a path of light between the light source and the diffusing member. The fluctuating light is transmitted through the screen and attenuated to form a three-dimensional image of flames which appears to curve around the simulated fuel bed.

In yet another aspect, the diffusing member is spaced apart from the front member to attenuate the fluctuating light transmitted through the screen to form the three-dimensional image of flames.

In yet another aspect, the invention provides a flame simulating assembly for providing an image of flames. The flame simulating assembly has a simulated fuel bed defining a profile thereof, a light source, and a screen positioned behind the simulated fuel bed for transmitting and diffusing light. The screen includes a plurality of curved portions, each curved portion being adapted to attenuate the image of flames upon transmission thereof through the screen to give at least a portion of the image of flames a three-dimensional appearance. The flame simulating assembly also includes a flicker element for causing light from the light source to fluctuate to form the image of flames, the flicker element being positioned between the light source and the screen.

In an additional aspect, the curved portions are randomly positioned in the screen.

### BRIEF DESCRIPTION OF THE DRAWINGS

For a better understanding of the present invention, and to show more clearly how it may be carried into effect, reference will now be made, by way of example, to the accompanying drawings. The drawings show preferred embodiments of the present invention, in which:

FIG. 1 is a perspective view of an electric fireplace incorporating a flame simulating assembly in accordance with the present invention;

FIG. 2 is a side view of the assembly of FIG. 1 showing elements behind the side wall;

FIG. 3 is a front view of the assembly of FIG. 1 showing elements below the top wall;

FIG. 4 is a top view of the assembly of FIG. 1 showing elements behind the front wall;

FIG. 5 is a front view of a flame effect element for the assembly of FIG. 1;

FIG. 6 is a perspective view of the upper flicker element for the assembly of FIG. 1, as viewed along a direction shown by arrow 6 in FIG. 3;

FIG. 7 is a partial plan view of a length of material defining a plurality of radial strips for the upper flicker element of FIG. 1;

FIG. 8 is a perspective view of the lower flicker element for the assembly of FIG. 1, as viewed along a direction shown by arrow 8 in FIG. 3;

FIG. 9 is a top view of a fuel bed light assembly for the assembly of FIG. 1 in accordance with a further embodiment of the present invention;

FIG. 10 is a side view of a second embodiment of the flame simulating assembly showing an alternative orientation of the flicker elements;

FIG. 11 is a front view of a second embodiment of the vertical screen showing the partially reflecting surface divided into regions:

FIG. 12 is an exploded detail view of a second embodiment of the fuel bed;

FIG. 13 is a side view of a third embodiment of the flame simulating assembly showing an alternative flame effect element;

FIG. 14 is a front view of the flame effect element for the assembly of FIG. 13;

FIG. 15 is a perspective side view of a fourth embodiment of the flame simulating assembly, showing an alternative flame effect element and an alternative vertical screen;

FIG. 16 is a perspective side view of an alternative vertical screen assembly for the assembly of FIG. 1 or FIG. 15;

FIG. 17 is a front view of the flame effect element for the assembly of FIG. 15;

FIG. 18 is a front perspective view of an electric fireplace incorporating a fire wall simulating assembly;

FIG. 19 is a perspective side view of the fireplace of FIG. 18;

FIG. 20 is an enlarged perspective view of the inner surface of the front wall of the assembly of FIG. 18;

FIG. 21 is a partial plan view of a length of material defining a plurality of radial strips for an alternative embodiment of the upper flicker element of FIG. 1 or FIG. 15;

FIG. 22 is an isometric view of a preferred embodiment of the flame simulating assembly;

FIG. 23 is a front view of the flame simulating assembly of FIG. 22;

FIG. 24 is a cross-section of the flame simulating assembly of FIG. 22 taken along line 24-24 in FIG. 23, drawn at a larger scale;

FIG. 25 is a cross-section of another embodiment of the flame simulating assembly of the invention;

FIG. 26 is a cross-section of yet another embodiment of the flame simulating assembly of the invention:

FIG. 27 is a cross-section of yet another embodiment of the flame simulating assembly of the invention;

FIG. 28 is a cross-section of yet another embodiment of the flame simulating assembly of the invention;

FIG. 29 is an isometric view of yet another embodiment of the flame simulating assembly of the invention, drawn at a smaller scale;

FIG. 30 is a front view of the flame simulating assembly of FIG. 29;

FIG. 31 is a cross-section of the flame simulating assembly of FIG. 29, taken along line 31-31 shown in FIG. 30, drawn at a larger scale;

FIG. 32 is a cross-section of yet another embodiment of the flame simulating assembly of the invention;

FIG. 33 is an isometric view of yet another embodiment of the flame simulating assembly of the invention, drawn at a smaller scale;

FIG. 34 is a front view of the flame simulating assembly of FIG. 33; and

FIG. 35 is a cross-section of the flame simulating assembly of FIG. 33, taken along line 35-35 in FIG. 34, drawn at a larger scale.

### DETAILED DESCRIPTION OF THE PREFERRED EMBODIMENT

A flame simulating assembly in accordance with the present invention is shown generally at 10 in the figures. The assembly is incorporated within an electric fireplace which is depicted generally at 12 with an electrical connection 13 for connecting to a power source (not shown).

The electric fireplace 12 includes a housing 14 that defines a simulated firebox having top, bottom, front, rear and side walls 16, 18, 20, 22 and 23, respectively. A portion of the front wall is defined by a transparent front panel 24 that is removable to permit access to the contents of the housing 14. A control unit 21 is located above the top wall of the housing. The control unit 21 includes a heater unit 25, a thermostat 27 for controlling the heat output and a main power switch 29 for actuating the flame effect.

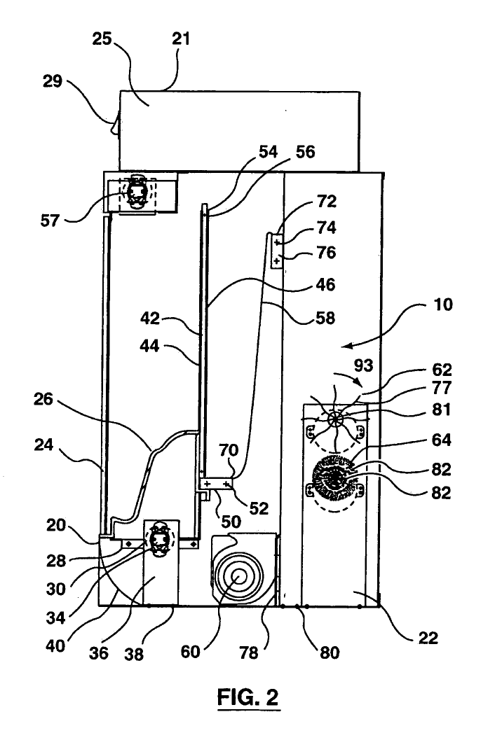

Referring to FIG. 2, a simulated fuel bed 26 is supported on a platform 28 located at a lower front portion of the housing 14. The fuel bed 26 comprises a plastic shell that is vacuum formed and colored to resemble logs and embers for a log burning fire.

Portions of the shell are translucent to permit light from a light source 30 located beneath the fuel bed 26 to shine through. For instance, the shell may be formed from an orange translucent plastic. The top side of the plastic shell may be painted in places to resemble the surface of logs. The underside of the plastic shell may be painted black (or some other opaque color) and then sanded in portions where it is desired for light to pass. For instance, the protruding points on the underside of the shell (corresponding to indents in the top side) may be sanded to allow light passage. These points would thus resemble the embers of a fire. Also, the crotch area between simulated logs may be sanded (or left unpainted) to resemble embers at the intersection of two logs.

The light source 30 comprises three 60 watt light bulbs that are supported in sockets 34 below the fuel bed 26. Alternatively, one or more quartz halogen lights may be utilized. The sockets 34 are supported by vertical arms 36 that are connected with fasteners 38 to the bottom wall of the housing 14. A parabolic reflector 40 is located below the light source 30 at the lower front end of the housing 14 to direct light toward the rear of the housing 14. The intensity of the light can be varied with a dimmer switch 41 that is electrically connected to the light source 30 and located on the control unit 21.

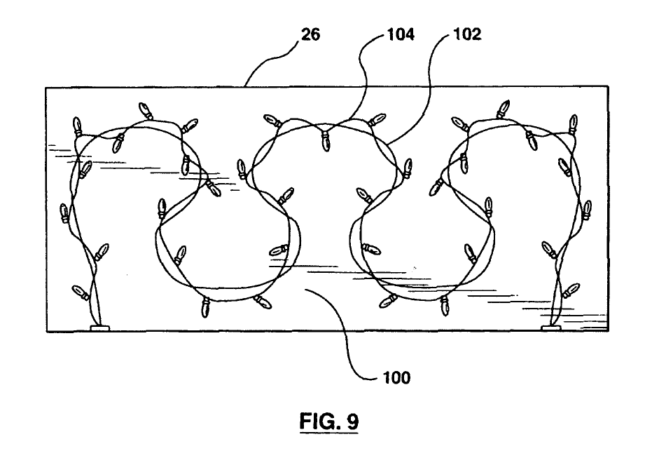

In a further embodiment of the invention as shown in FIG. 9, a fuel bed light assembly 100 may be arranged beneath the underside of the fuel bed 26. The fuel bed light assembly 100 includes a support element 102 that supports a string of lights 104 beneath the fuel bed 26. The lights 104 are adapted to flicker at different times to give the impression of increases and decreases in heat (as depicted by differences of light intensity) in the embers of the fuel bed. It has been found that conventional Christmas lights are suitable for this purpose. It has also been found that a realistic ember effect may be generated by positioning four regular light bulbs beneath the bed and randomly varying the intensity of the lights using a micro-processor (not shown).

Located immediately behind the fuel bed 26 is a vertical screen 42. The screen 42 is transparent and has a partially reflecting surface 44 and a diffusing surface 46. The screen 42 is seated in a groove 48 defined in a lower horizontal support member 50. The lower horizontal support member 50 is fastened to the side walls 23 of the housing 14 with fasteners 52. The screen 42 is supported on its sides with side frame members 54 that are fastened to the side walls 23 with fasteners 56. The screen structure is described in more detail in U.S. Pat. No. 4,965,707 which is hereby incorporated herein by reference.

The screen 42 is positioned immediately behind the fuel bed 26 so that the fuel bed 26 will be reflected in the reflecting surface 44 to give the illusion of depth. As will be explained further below, the image of simulated flames appears to be emanating from between the fuel bed 26 and the reflection of the fuel bed 26 in the screen. Also, simulated flames appear to be emanating from the reflected image of the fuel bed 26. An upper light source 57 is located at the top front portion of the housing for illuminating the top of the simulated fuel bed 26 and enhancing the reflected image in the screen 42.

Referring more closely to the flame simulation assembly 10, the assembly includes a flame effect element 58, a blower 60 and upper and lower flicker elements 62 and 64.

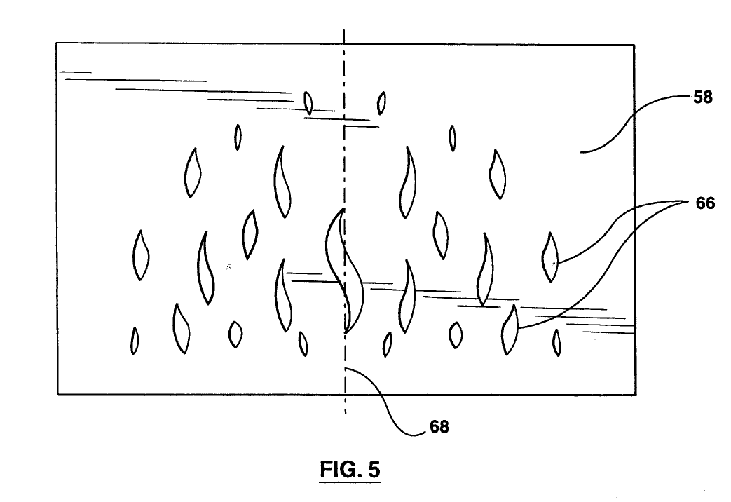

As shown in FIG. 5, the flame effect element 58 is formed from a single thin sheet of a light-weight, substantially opaque, material such as polyester. The element 58 extends across substantially the full width of the screen 42. A plurality of slits 66 are cut into the flame effect element 58 to permit passage of light through the flame effect element 58 as it billows under the influence of air currents from the blower 60. Longer sized slits 66 are located at the lower end of the flame effect element 58 to simulate longer flames emanating from the fuel bed 26. Smaller slits 66 are located at the upper end of the flame effect element 68 to simulate the licks of flames that appear above the large main flames emanating from the fuel bed .26. The slits 66 are arranged in a pattern that is symmetrical about a center axis 68 of the flame effect element 58 to give a balanced appearance to the flame effect The element 58 may be coated with plastic film (such as polyurethane) to retard fraying about the edges of the slits. Alternatively, the flame effect element could comprise a plurality of discrete flame effect elements 58 as disclosed in U.S. Pat. No. 4,965,707 which is hereby incorporated herein by reference.

The flame effect element 58 is supported at its bottom end by fasteners 70 that connect to the lower horizontal support member 50. The flame effect element 58 is supported at its upper end by fasteners 72 that connect to an upper horizontal support member 74. The upper horizontal support member is connected by fasteners 76 to the side walls of the housing 14.

The flame effect element 58 is supported relatively loosely between the horizontal supports so that it will billow or ripple with the air currents from the blower 60. The blower 60 is supported by a mounting bracket 78 that is supported with fasteners 80 to the bottom wall of the housing 14. An airflow control switch 79 is provided on the control unit 21 to vary the blower airflow to a desired amount. The greater the airflow, the more active the flame will appear. Alternatively, the flame effect element 58 may be moved mechanically to produce sufficient billowing or rippling to give the flame effect.

In use, light is transmitted from the light source 30 through the slits 66 of the flame effect element 58 to the diffusing surface 46 of the screen 42. The flame effect element 58 billows in the airflow from the blower 60 to vary the position and size of the slits 66. The resulting effect is for the transmitted light to resemble flames licking from a fire. As will be explained further below, the transmitted light is at least partially colored due to its reflecting from a colored reflecting surface 77 of a flicker element 62, 64 prior to passing through the slits 66.

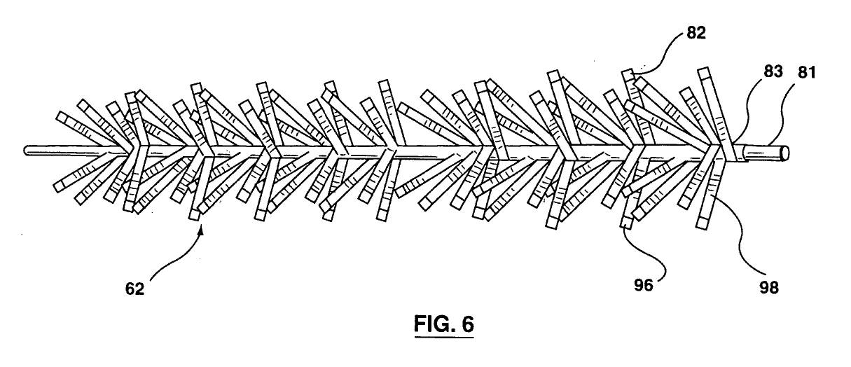

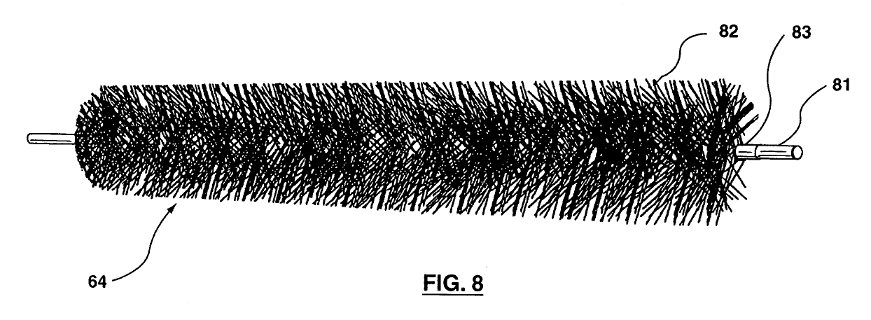

The upper and lower flicker elements 62, 64 are located rearwardly from the flame effect element 58 proximate to the rear wall of the housing 14. As shown in FIGS. 6 and 8, each flicker element comprises an elongate rod 81 having a plurality of reflective strips 82 extending radially outwardly therefrom. The flicker elements 62, 64 preferably have a diameter of about two to three inches. The strips 82 are formed from a length of material having a width of approximately one and a half inches. A series of transverse slits are cut along one elongate side of the length of the material 83 to define each individual strip 82. The length of material 83 is then wrapped bout the rod 81 so that the strips 82 protrude radially about the full circumference of the rod 81. Alternatively, the strips 82 may be cut to lengths of around two to three inches and clamped at their centers by spiral wound wires that form the rod 81. Alternatively, the reflective surfaces of the flicker elements could be mirrored glass pieces arranged about the surface of a cylinder.

The rods 81 are supported at one end in corresponding recesses 84 defined in a vertical support arm 86 that is connected by fasteners 88 to the bottom wall of the housing 14. The rods 81 are connected at their other end to corresponding rotors 90 for rotating each rod 81 about its axis. The rotors 90 are rotated by electric motors 91 as shown. The rotors 90 are supported by a vertical support member 92 that is connected with fasteners 94 to the bottom wall of the housing 14. Alternatively, the rotor 90 may be rotated by air currents from the blower 60 engaging corresponding fins on the rotors. Preferably, the rotors 90 rotate the flicker elements 62, 64 in the direction indicated by arrow 93 in FIG. 2 so that an appearance of upward motion is imparted on the reflected light images. This simulates the appearance of upwardly moving gasses from a fire. It is contemplated that other means for simulating the appearance of upwardly moving gasses may be used. For instance, a light source (not shown) may be contained within a moving, partially opaque, screen (not shown) to produce the desired light effect. It is also contemplated that the flicker elements 62, 64 or the above described gas simulating means may be used alone without the flame effect element 58. It has been found that the use of the flicker elements 62, 64 alone produces a realistic effect although not as realistic as when used in combination with the flame effect element 58.

Referring to FIG. 2, it may be seen that the lower flicker element is positioned slightly below the horizontal level of the upper end of the fuel bed 26. This facilitates the appearance of upwardly moving gasses and colored flames emanating from near the surface of the fuel bed when viewed by a person in front of the fireplace. Similarly, the upper flicker element is positioned at a horizontal level above the fuel bed 26 to give the appearance of upwardly moving gasses and colored flames emanating a distance above the fuel bed when viewed by a person in front of the fireplace. In addition, the upper and lower flicker elements 62, 64 improve the light intensity of the simulated flame and gasses.

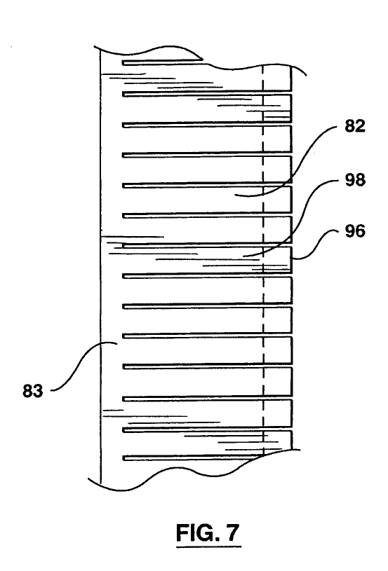

Referring more closely to FIG. 7, the strips 82 for the upper flicker element 62 are shown. Each strip 82 is formed from a reflective material such as MYLAR™. The strip 82 is preferably colored with either a blue or red tip 96 and a silver body 98, although a fully silver body has been used successfully as well. A length of material 83 with red tipped strips 82 and a length of material 83 with blue tipped strips 82 may both be wrapped about the rod 81. As shown in FIG. 6, a combination of blue and red tipped strips 82 protrude radially from the rod 81 over the entire length of the flicker element 62. As a result, the upper flicker element 62 reflects white, red and blue light that is subsequently transmitted through the flame effect element 58.

The lower flicker element 64, as shown in FIG. 8, comprises a dense arrangement of thin strips 82 that are formed from a reflective material such as MYLAR™. The strips 82 are either substantially gold in color, or substantially red in color. A combination of lengths of material 83 with red strips 82 and gold strips 82 may be wrapped around the rod 81 to produce an overall red and gold tinsel appearance. As a result, the lower flicker element 64 reflects yellow and red light that is subsequently transmitted through the flame effect element 58.

In use, the flicker elements 62, 64 are rotated by the rotors 90 so that the reflective surfaces of the strips 82 reflect colors through the slits 66 of the billowing flame effect element 58 and produce the effect of upwardly moving gasses. The colors reflected by the lower flicker element 64 resemble the colors of flames located near the surface of the fuel bed 26. The colors reflected by the upper flicker element 62 resemble the colors of flames that are located further from the surface of the fuel bed 26. The upper flicker element 62 has a less dense arrangement of strips 82 in order to produce more random reflections that simulate a more active flickering flame at a distance above the fuel bed 26. The more dense arrangement of strips 82 in the lower flicker 64 produces relatively more constant reflections that simulate the more constant flame activity adjacent to the fuel bed 26.

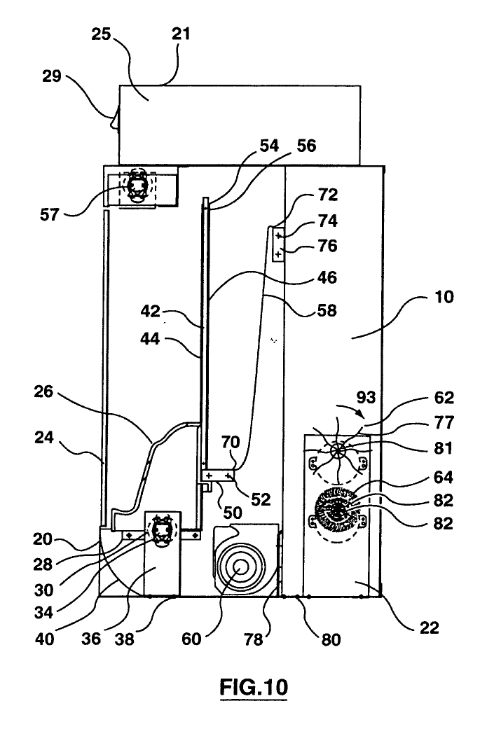

Referring to FIG. 10, an alterative orientation for the flicker element 62, 64 is shown. The upper flicker element 62 is positioned slightly below the horizontal level of the upper end of the fuel bed 26. The lower flicker element 64 is positioned slightly above the horizontal level of the lower end of the fuel bed 26. The lower flicker element 64 is positioned slightly above the horizontal level of the lower end of the fuel bed 26.

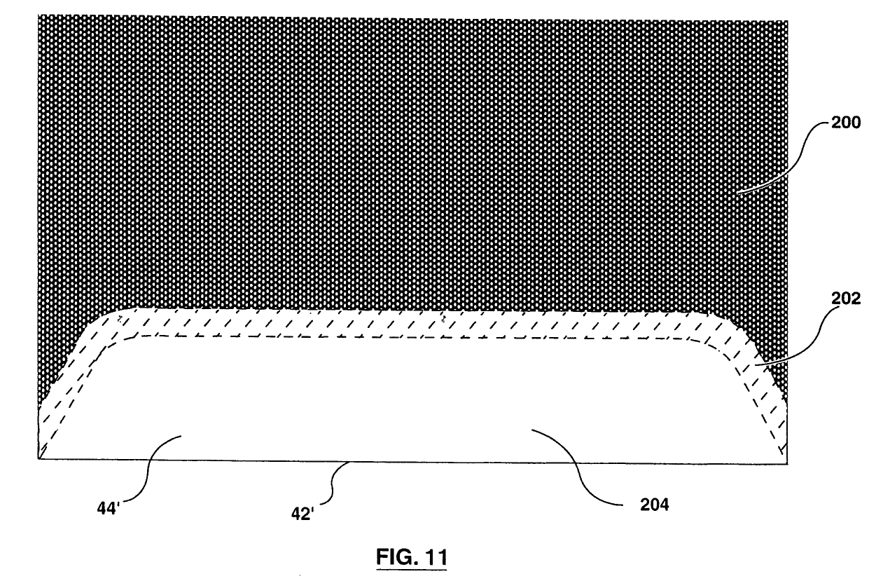

Referring to FIG. 11, an improved vertical screen 42′ is depicted. The front of the screen includes a partially reflecting surface 44′ that is divided into a matte region 200, a transition region 202 and a reflecting region 204. The reflecting region 204 is located at the lower end of the vertical screen 42′ and is sufficiently sized for reflecting the fuel bed 26 to produce the simulated effect At the same time, the reflecting region 204 is not overly sized so as to reflect unwanted images such as the floor covering located immediately in front of the fireplace. For this reason, the vertical screen 42′ includes the matte region 200 at its middle and upper end. The matte region 200 has a matte finish that does not reflect images while still permitting visibility of the simulated flame image through the vertical screen 42′. The transition region 202 comprises a gradual transition between the non-reflective matte region 200 and the reflecting region 204.

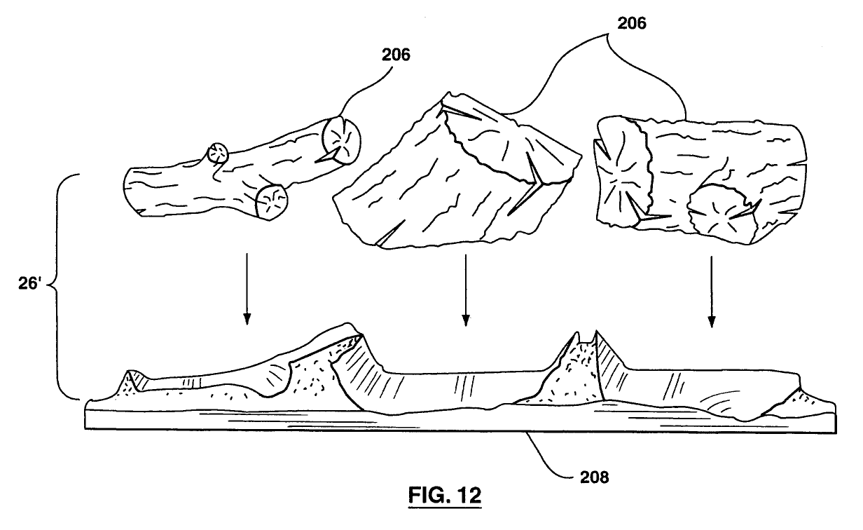

Referring to FIG. 12, an improved fuel bed 26′ is shown. The fuel bed 26′ includes a first portion 206 composed of a ceramic material and formed and colored to simulate logs. The bed 26′ also includes a second portion 208 composed of a plastic material and formed and colored to simulate an ember bed. The ember bed 208 is preferably translucent to permit the passage of light from the light source 30 or fuel bed light assembly 100 as described earlier. It has been found that a more accurate simulation of logs 206 can be accomplished using ceramic materials and flexible molds. The ember bed 208 can still be formed realistically from plastic using a vacuum forming method. The bed is formed to receive the ceramic logs 206. The ceramic logs 206 are then glued to the ember bed 208 to form the fuel bed.

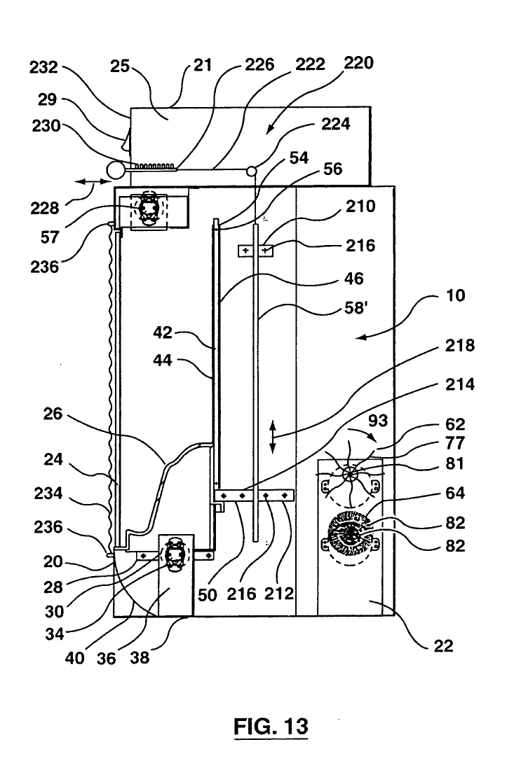

Referring to FIGS. 13 and 14, a third embodiment of the flame simulating assembly is depicted. For convenience, the same reference numbers have been used to refer to the same elements. The third embodiment does not include the blower 60 or the light-weight flame effect element 58 which was adapted to billow in the airflow of the blower. Instead, an improved flame effect element 58′ is positioned behind and substantially across the full width of the screen 42. The improved flame effect element 58′ is similar in appearance to the flame effect element 58 depicted in FIG. 5. However, the improved flame effect element 58′ is positioned preferably in a generally vertical plane approximately three inches behind the screen 42 (and about ½ inch from the flicker elements 62, 64). The element 58′ is preferably formed of a more rigid material (e.g. plastic or thin steel) so that it will remain generally stationary in its vertical position. However, a light-weight material such as polyester may be used instead with the element 58′ being stretched taut into a vertical position. Furthermore, it should be understood that a vertical position for the element 58′ is not critical, so long as light passage is possible as described below.

A plurality of slits 66′ are cut into the flame effect element 58′ to permit passage of light from the light source 30 through the flame effect element 58′ to the screen 42. While the improved flame effect element 58′ remains relatively stationary, the flame simulation effect is nonetheless observable due to the reflection of light from the flicker elements 62 and 64 as the light passes through the slits 66′.

The improved flame effect element 58′ is sandwiched between upper and lower support elements 210 and 212 to support the flame effect element in a generally vertical position. The lower horizontal support member 50 acts as one of the lower support elements. In addition, lower horizontal support member 50 acts as a horizontal opaque screen 214 to block light from passing below the screen 42 and flame effect element 58′. In this manner, substantially all of the light reaching the screen 42 has been reflected by flicker elements 62 and 64 and passes through slits 66′ in the flame effect element 58′. The upper and lower support elements 210 and 212 are fastened to the side walls 23 of the housing 14 with fasteners 216.

Alternatively, the element 58′ could be formed with a horizontal living hinge at its lower end. The portion below the living hinge could be connected to the screen 42 and act as the horizontal opaque screen 214. The portion above the screen should be supported at least at its upper end by the upper support element 210. The living hinge allows the element 58′ to be moved up or down as described below.

The flame effect element 58′ is preferably movable upwardly or downwardly relative to the screen 42 in the direction of arrows 218. This is accomplished by a height adjustment mechanism shown generally at 220. The mechanism 220 includes a wire 222 connected to the top of the flame effect element 58′. The wire 222 extends over a pin 224 and connects at its other end to the end of a height adjusting knob 226. The height adjusting knob 226 protrudes from the front of the control unit 21 and is capable of being moved inwardly and outwardly relative to the front face of the control unit 21 in the direction of arrows 228. The height adjusting knob 226 includes a plurality of teeth 230 that engage the front face 232 of the control unit 21 to permit the knob 226 to be secured inwardly or outwardly relative to the control unit 21 in one of a plurality of positions. It has been found that, by raising or lowering the flame effect element 58′ by a predetermined amount, the perceived intensity of the simulated flame (both the brightness and size of the flame) effect can be increased or decreased. It is believed that this change in intensity is due to the different sized slits 66′ defined in the flame effect element 58′ being more or less visible to an observer positioned in front of the fireplace 12. It will be appreciated that alternative height adjustment mechanisms may be chosen. For instance, the knob 226, may be connected to the flame effect element 58′ by a cam arrangement for mechanically moving the element 58′ up or down.

The embodiment depicted in FIG. 13 further includes a simulated fire screen 234 covering the front face 232 of the transparent front panel 24. The simulated fire screen 234 is preferably a woven mesh such as is known for blocking sparks for conventional fireplaces. The woven mesh fire screen 234 is supported at its top and bottom ends by pins 236 protruding from the front wall 20 of the housing 14. Alternatively, the simulated fire screen 234 can be defined directly on the transparent front panel 24 using a silk screen process or the like. It has been found that the simulated fire screen 234 reduces any glare or reflection that otherwise might be visible on the transparent front panel 24.

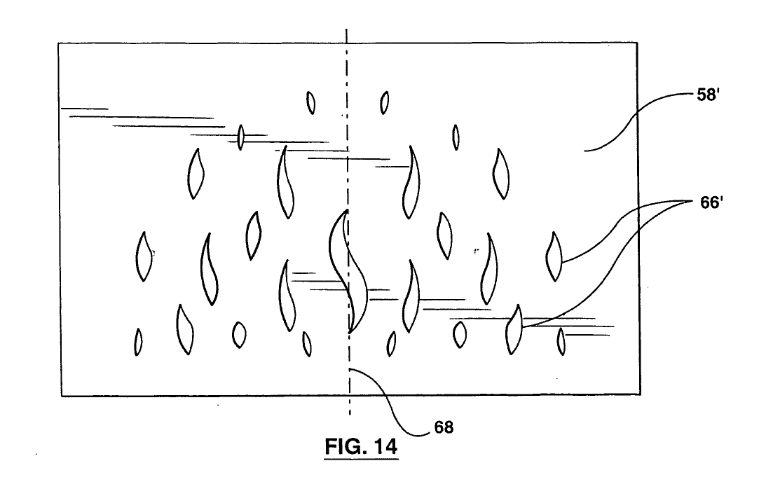

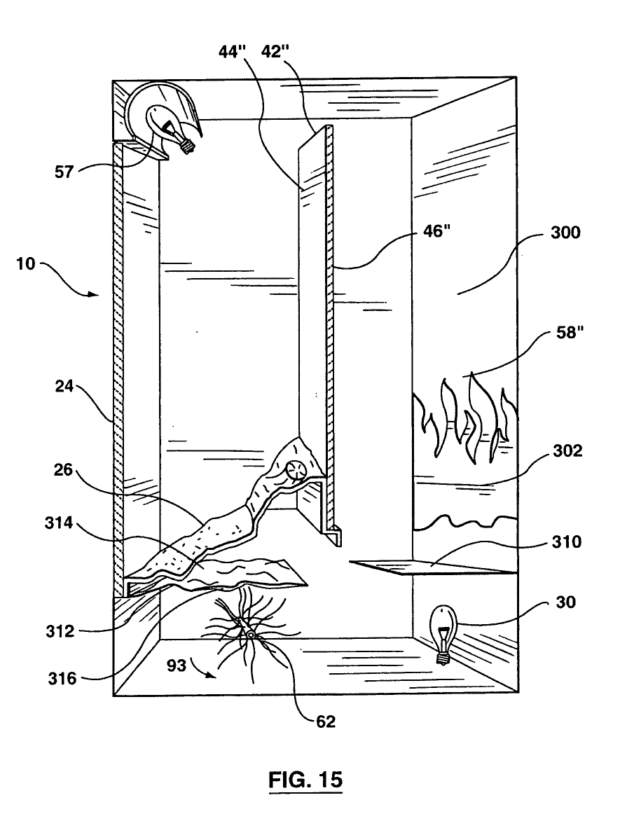

Referring to FIG. 15, a further improved vertical screen 42″ is shown. The screen 42″ is generally transparent and has a partially reflecting surface 44″ and a diffusing region 46″ through its thickness. The screen 42″ is fabricated from, a generally transparent but partially translucent material preferably having a slightly clouded or milky appearance through its thickness, such that light passing through the screen 42″ is partially transmitted and partially diffused. A satisfactory material is a polystyrene which is given a slightly milky appearance by the addition of an amount of a powdered white pigment, such as titanium dioxide. The particle size of the pigment material is preferably microscopic so that a uniformly clouded or milky appearance is imparted to the diffusing region 46′. The amount of diffusion achieved by diffusing region 46″ can be controlled by the amount of pigment added to the plastic composition of diffusing region 46″. The amount of diffusion achieved by diffusing member 46″ should be such that a three-dimensional flame appears through the thickness of diffusing member 46″, when viewed through partially reflecting member 44″.

By diffusing the projected light of the simulated flame gradually through the thickness of the screen 42″, the improved screen 42″ gives an apparent thickness to the simulated flame, creating the illusion of a three dimensional flame. Furthermore, the improved screen 42″ does not rely on a sandblasted or etched surface for its diffusing effect and therefore simplifies construction of assembly 10.

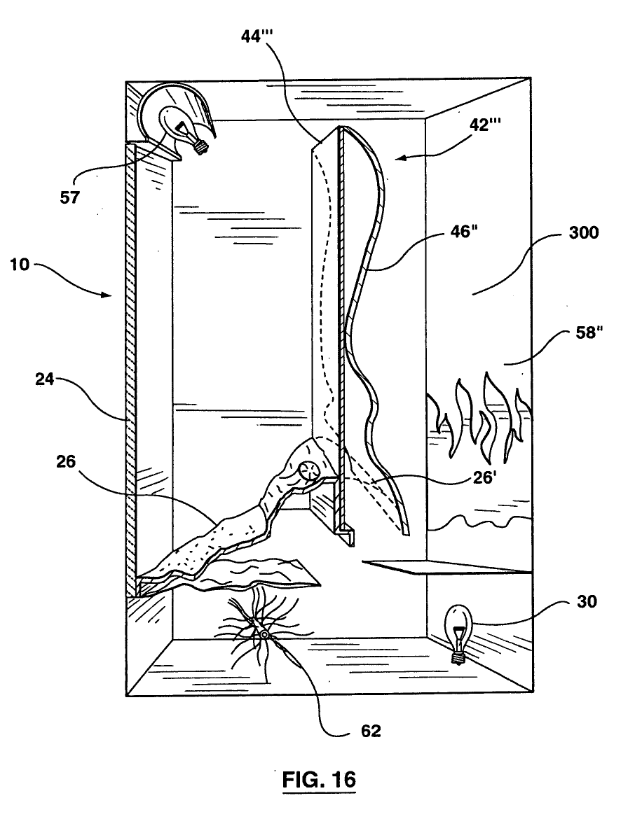

Referring to FIG. 16, a further improved vertical screen assembly 42′″ is shown. The screen 42′″ is composed of a reflecting member 44′″ and a diffusing member 46′″. The reflecting member 44′″ is fabricated from a partially transparent, partially reflective material, such as semi-silvered glass. Diffusing member 46′″ is fabricated from a translucent material that partially transmits and partially diffuses light passing through the diffusing member 46′″. Diffusing member 46′″ may be made from a transparent material similar to that used in screen 42, and given an etched or sand blasted diffusing surface, similar to diffusing surface 46. Alternatively, translucent materials, such as white polystyrene and polypropylene, have also been found to be suitable for diffusing member 46′″. Where a translucent material is used, the thickness of a particular material used for diffusing member 48′″ is chosen to allow diffusing member to be self-supporting and yet remain translucent enough that a flame effect is observable thereon through partially electing member 44′″. Diffusing member 46′″ does not necessarily embody the elements of diffusing screen 46″, described above.

Diffusing member 46′″ is not planar but rather curved along its length and width, the direction and amount of the curvature varying both vertically and horizontally along diffusing member 46′″. Diffusing member 46′″ may be conveniently formed by vacuum-forming a sheet of plastic to the desired shape. The curvature, in the vertical direction, of the lower portion of diffusing member 46′″ preferably follows the apparent location of fuel bed 26 in reflecting member 44′″ (indicated at 26′) to give the appearance that the simulated flames projected thereon are emanating from behind the reflection 26′ of fuel bed 26. For example, if fuel bed 26 included simulated wood logs, the simulated flames projected on diffusing member 46′″ would appear to be emanating from behind the reflection 26′ of the simulated logs in fuel bed 26. The curvature of the lower portion diffusing member 46′″, in the horizontal direction along fuel bed 26, preferably tracks the particular angle at which a simulated log appears to lay in fuel bed 26 and follows the apparent location of the log in reflecting member 44′″ (indicated at 26′). At a horizontal position on fuel bed 26 where no simulated log appears, diffusing member 46′″ is locally curved to be adjacent reflecting member 44′″ to give the appearance that the simulated flames projected thereon are emanating from the embers between the simulated logs of fuel bed 26.

As diffusing member 46′″ rises vertically away from fuel bed 26, it preferably then curves generally closer to reflecting member 44′″ to create the illusion that simulated flames projected thereon are licking over the logs of fuel bed 26. The curvature of the upper portion of diffusing member 46′″ may be appropriately chosen to further simulate the turbulent and random pattern of a real flame.

The vertical screen assembly 42′″ adds an additional three-dimensional effect to the simulated flame. When viewed through partially reflecting member 44′″, the simulated flame appears to emanate from behind the simulated logs of fuel bed 26 and subsequently travel a three-dimensional path as it appears to rise from fuel bed 26. which more accurately simulates the appearance of a real wood fire.

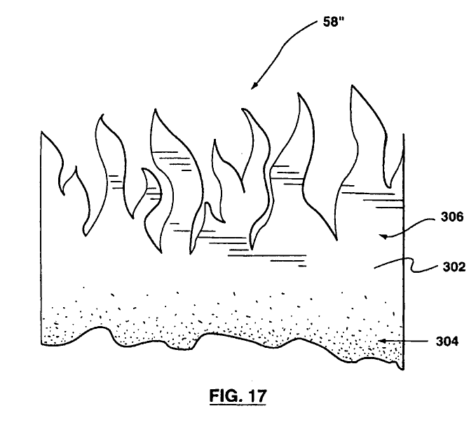

Referring to FIGS. 15 and 17, a fourth embodiment of flame simulating assembly 10 is depicted. For convenience the same reference numbers have been used to refer to the same elements. The fourth embodiment does not include a blower 60 or a light-weight flame effect element 58 adapted to billow in the airflow of blower 60. Instead, an improved and simpler flame effect element 58″ is positioned behind and substantially across the full width of the screen 42″ (a screen 42, as shown in FIG. 2, may equally be used), and in front of back wall 300. The improved flame effect element 58″ has a reflective surface 302 and generally has a flame-like profile, as depicted in FIG. 17. Back wall 300 has a non-reflective surface. In a preferred embodiment, the element 58″ is a reflective decal applied to the surface of back wall 300. To simulate the colors of a natural flame, flame effect element 58″ is preferably colored with a bluish or greenish base portion 304 and a silver body 306. The transition between the blue portion 304 and the silver 306 is made gradually as the intensity of the blue color in portion 304 is faded into silver portion 306.

Referring again to FIG. 15. a single flicker element 62, rotating in direction 93, is positioned below the fuel bed 26 and generally in front of flame effect element 58″. Adjacent and behind the flicker element 62 is positioned the light source 30. A light block 310 is provided to prevent light from light source 30 from reaching the flame effect element 58″ directly. Hence, substantially only light reflected from flicker element 62 reached flame effect element 58″ and is subsequently reflected to, and transmitted through screen 42″. The apparent intensity of the simulated fire is proportionate to the speed at which flicker element 62 turns. A variable speed control (not shown) for flicker element 62 may be provided to allow the user to alter the apparent intensity of the simulated fire.

The introduction of a fixed flame element 58″ removes previous problems of silk element 58 clinging to screen 42″. Further, the improved design removes the need for blower 60 and lower flicker 64, making assembly 10 simpler to manufacture and maintain. Furthermore, by repositioning the flicker element 62 beneath fuel bed 26, a more compact flame simulating assembly 10 may be achieved or, alternatively, fuel bed 26 may be moved further back, away from front panel 24, giving assembly 10 the look of a deeper, more realistic fireplace. Also, the repositioning of flicker element 62 further simplifies the invention by removing the need for a light source 30 with flickering intensity.

The embodiment depicted in FIG. 15 may further include a transparent light randomizing panel 312, positioned between fuel bed 26 and flicker element 62. The panel 312 is preferably made of glass or optical grade plastic and has non-planar surfaces 314 and 316. The surfaces 314, 316 each have convex and concave regions which smoothly and contiguously blend into one another, resulting in a panel 312 having a varied thickness. In use, panel 312 acts as a complex lens, with regions of varied focal length, to light reflecting towards fuel bed 26 from flicker element 62, which is rotating in direction 93. The effect of the complex lens-like characteristics of panel 312 is to intermittently reverse the direction of the reflected light from flicker element 62 as it crosses fuel bed 26. The result is that the simulated coals of fuel bed 26 appear to flicker in a random direction, and not only in the direction of rotation of flicker element 62.

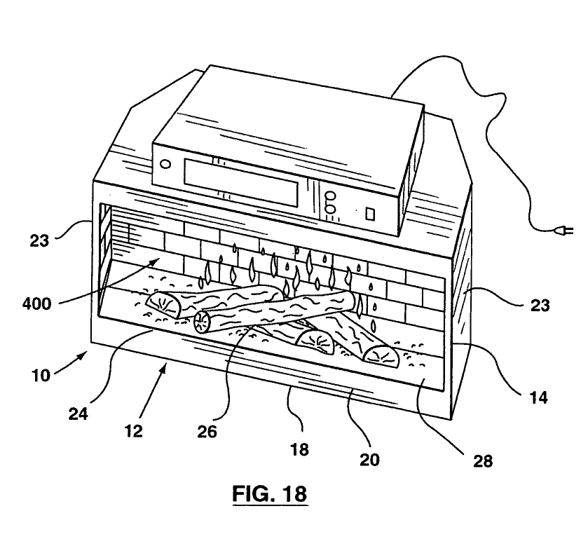

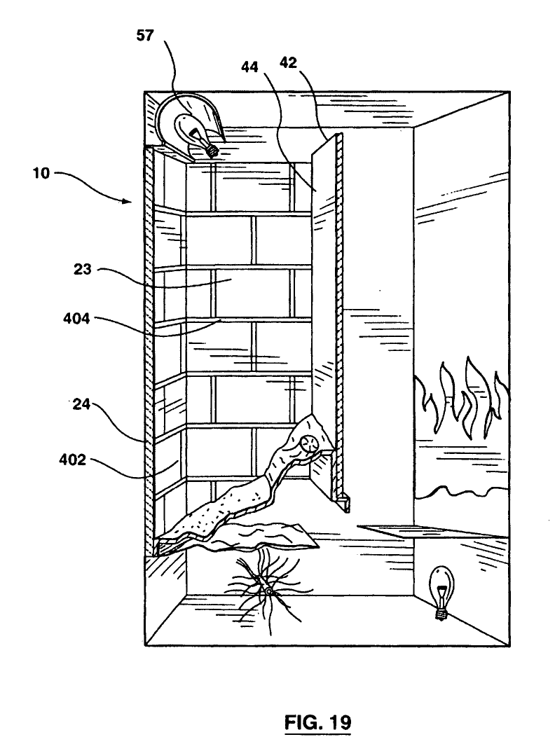

Referring to FIGS. 18, 19 and 20, a further improved flame simulating assembly 10 with a simulated brick or rock fire wall 400 is depicted. For convenience, the same reference numbers have been used as previously to refer to the same elements. Referring to FIG. 19, simulated fire wall patterns 402, 404 are applied to the inner surfaces of transparent front panel 24 and each of side walls 23, respectively. Fire wall pattern 404 is applied by painting, or similar method, the pattern 404 on the inner surface of each side wall 23. The pattern 402, as will be explained further below, is applied to the inner surface of transparent front panel 24 preferably by applying, using a silk-screening method, a series of small colored dots in a random pattern. The dots are applied in such a manner that an observer positioned in front of transparent front panel 24 will not readily notice the dots applied to the inner surface of the panel 24 but will, however, notice the reflection of the dots in the reflecting surface 44. The effect gives the illusion of a fire wall appearing behind the image of the simulated flames emanating from the fuel bed 26. The light source 57 is provided beneath top wall 16 to light the pattern 402 to strengthen its reflection in surface 44. To create a more realistic lighting of patterns 402, 404, the light source 57 may be made to flicker randomly to simulate lighting on the simulated fire wall 400 by a real flame. The flicker in light source 57 could be achieved by integrated circuit control (not shown) of the electricity supplied to light source 57.

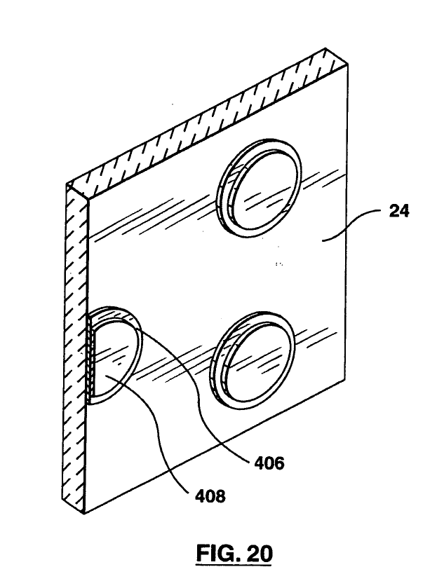

Referring to FIG. 20, a preferred method of applying pattern 402 to the interior surface of front panel 24 is shown. First, a random pattern of small dots 406 is applied to the inner surface of front panel 24. Although random, the pattern of dots 406 has a constant dot density per square inch across the entire inner surface of front panel 24. Dots 406 are preferably all the same size. The dot density and a size of dots 406 are preferably chosen such that the presence of the dots 406 is not readily noticeable to an observer and the only effect imparted to the glass by the presence of dots 406 is a smoked or tinted appearance to transparent front panel 24. This effect is best achieved if the dots 406 are black in color. Preferably the dots 406 are applied to the inner surface of panel 24 using a silk screening process. Once the dots 406 have been applied, a set of colored dots 408, of slightly smaller diameter than dots 406, is applied on top of dots 406. Dots 408 are of slightly smaller diameter than, and located concentrically on, dots 406 to ensure that an observer positioned in front of assembly 10 will not notice the presence of dots 408 on the inner surface of transparent panel 24. The dots 408 are also preferably applied using a silk screening process. Dots 408 preferably appear in two colors, the two colors being the color of the simulated brick and the color of the simulated mortar between the simulated bricks. The color of a particular dot 408 is preferably chosen such that an overall brick and mortar pattern is formed on the inner surface of front panel 24.

In use, the presence of the dots 406 and 408 on the inner surface of transparent front panel 24 is not readily noticed by an observer positioned in front of flame simulating assembly 10, however, the reflection of the colored dots 406 in reflecting surface 44 is readily apparent to the observer. The simulated fire wall 400 appears to the observer to be behind fuel bed 26 at twice the distance of front panel 24 to the back of fuel bed 26. By locating dots 406 randomly across the inner surface of front panel 24, a visible interference pattern is avoided. This interference pattern would appear if the dots were regularly located on the inner surface of front panel 24, the interference pattern being caused between the presence of dots 406, 408 on the inner surface of panel 24 and the reflection of dots 406, 408 on reflecting surface 44. Dots 406 are applied with a constant dot density per square inch to ensure that the smoked or tinted appearance which dots 406 impart to front panel 24 is constant across front panel 24. The colors chosen for pattern 402 are also the colors used for pattern 404 on side walls 23. The patterns 402 and 404 are positioned on the inner surface of front panel 24 and side walls 23, respectively, such that the apparent brick and mortar features of the two patterns intersect and mate in a realistic fashion.

It will be apparent that the simulated fire wall pattern 402 can also be achieved using alternate means. For example, a CLEAR FOCUS™ one-way vision display panel (not shown), as is described in U.S. Pat. No. 5,525,177, may be used. Simulated fire wall pattern 402 can be applied to the display surface of a CLEAR FOCUS™ panel which is, in turn, applied to the inner surface of front panel 24, such that an observer positioned in front of flame simulating assembly 10 cannot see pattern 402 directly but can view the reflection of pattern 402 in reflecting surface 44. In another embodiment, the transparent front panel 24 is replaced by a mesh front fire screen (not shown), and the simulated fire wall pattern 402 is applied, with paint or similar means, to the inner surface of the mesh front fire screen. If care is used to ensure that the pattern 402 is applied only to the interior surface of the mesh front fire screen, the pattern 402 will not be directly visible to an observer standing in front of flame simulating assembly 10. The observer will. however, be able to view the reflection of pattern 402 on reflecting surface 44.

It is readily apparent that the apparatus to produce simulated fire wall 400 could be used successfully with any fireplace having a front panel 24 and reflecting surface 44. In particular, it will be apparent that the inclusion of a simulated fire wall 400 would greatly enhance the appearance of a natural gas or propane fireplace. By using the disclosed apparatus to create a simulated fire wall 400, the depth of a fireplace may be decreased as a space-saving measure, however, an observer will not notice that the depth of the fireplace has been decreased.

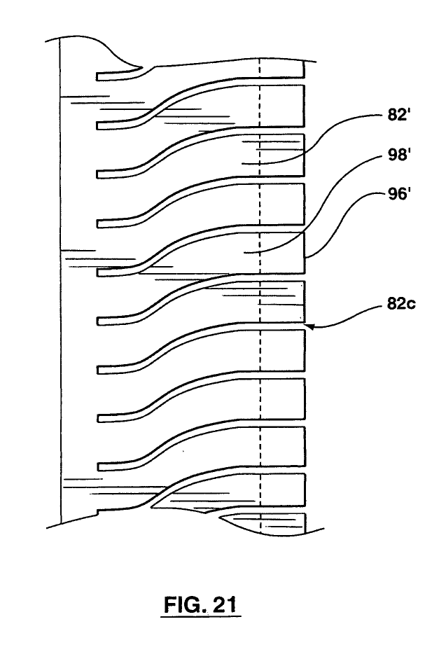

Referring to FIG. 21, improved strips 82′ for the upper flicker element 62 are shown. Since the sharp, straight lines of previous flicker element 62 gave sharp, straight reflections of light, which reduced the realism of the flame simulation, each improved strip 82′ is given a series of curvilinear cuts 82c. The result is an improved upper flicker element 62 which reflects non-rectilinear patterns of light that are subsequently transmitted through the flame effect element 58. The non-linear nature of the reflected light patterns improves the realism of the flicker in the simulated flame by causing the flickering patterns of reflected light to appear more random and therefore more natural.

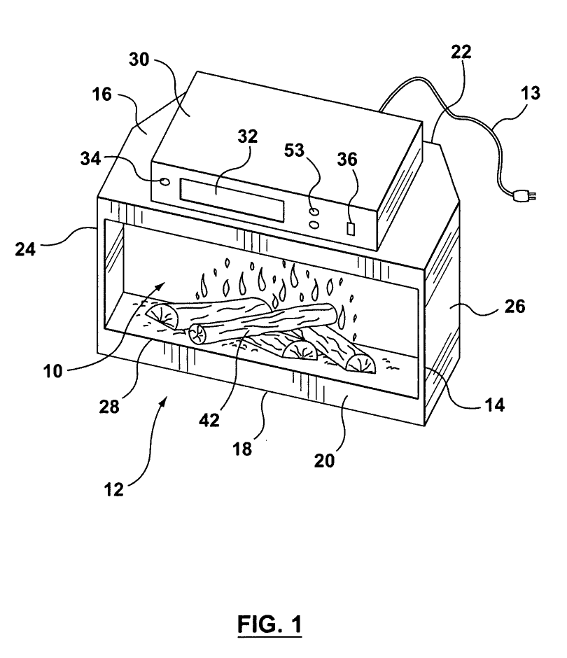

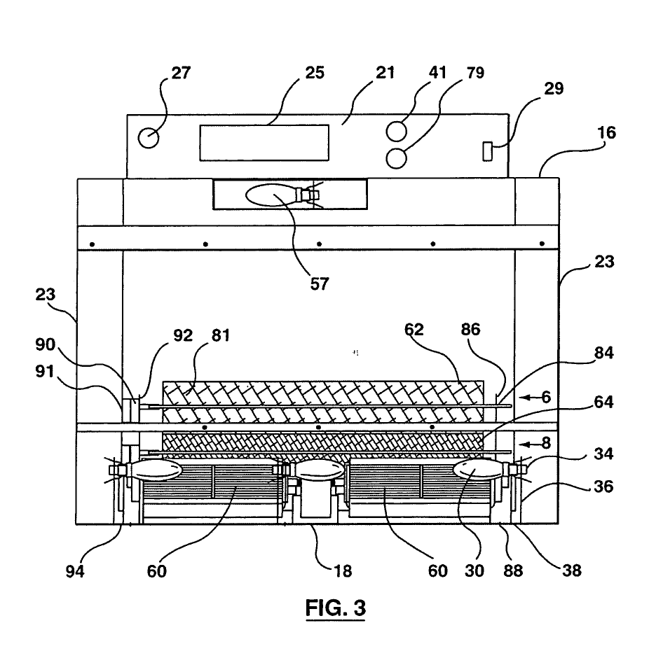

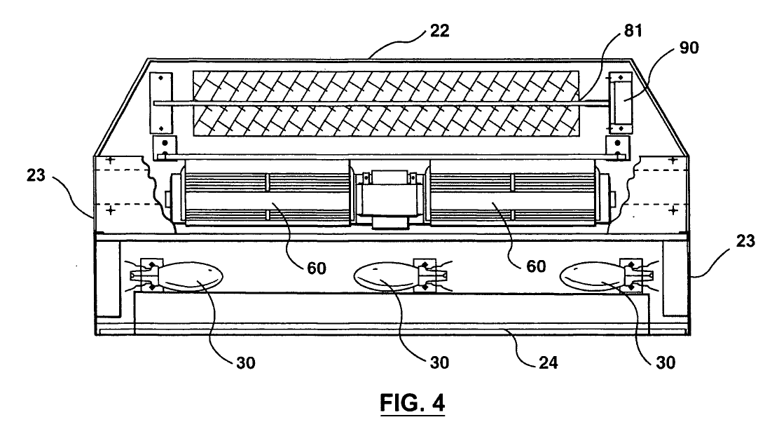

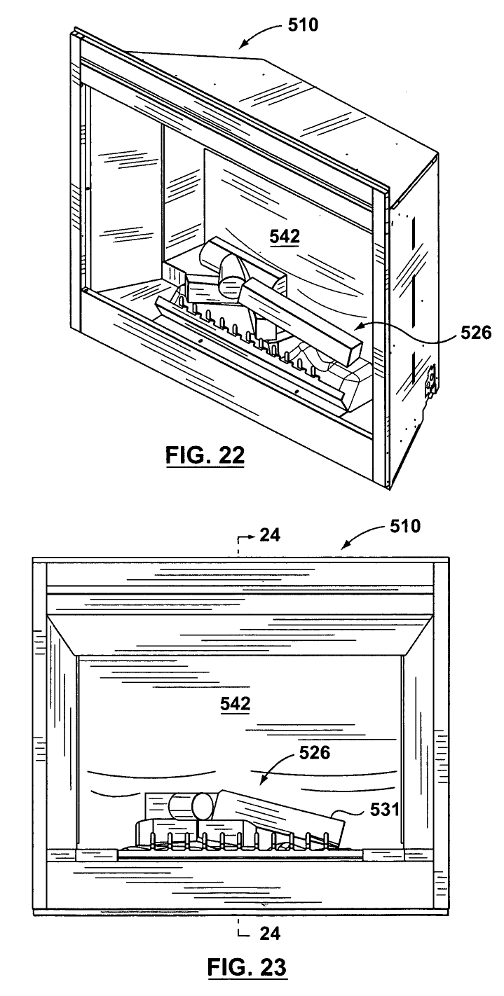

Additional embodiments of the invention are shown in FIGS. 22-35. In FIGS. 22-35, elements are numbered so as to correspond to like elements shown in FIGS. 1-21.

An alternative embodiment of a flame simulating assembly indicated generally by the numeral 510 in accordance with the invention is shown in FIG. 22. As can be seen in FIGS. 22-24, the flame simulating assembly 510 includes a simulated fuel bed 526, a light source 530, a screen 542, and a flicker element 561. The screen 542 is disposed behind the simulated fuel bed 526. As will be described, the screen 542 is for diffusing and transmitting light.

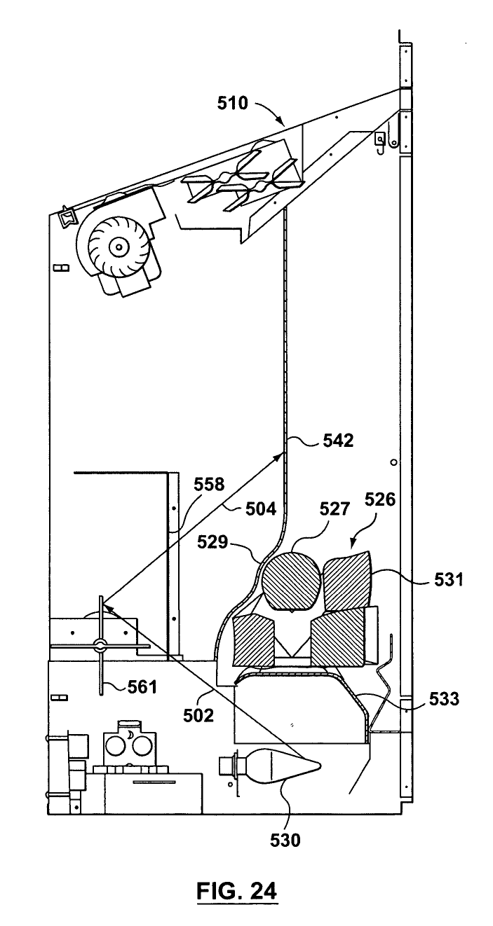

As can be seen in FIG. 23, the simulated fuel bed 526 defines a profile 527 which is viewable by an observer (not shown) observing, from a position in front of the flame simulating assembly 510, the simulated fuel bed 526 and the screen 542. FIG. 24 shows that the screen 542 includes a curved portion 529 which is curved in a vertical direction and in a horizontal direction to correspond to the profile 527 of the simulated fuel bed 526. The curved portion 529 of the screen 542 is positioned adjacent to the simulated fuel bed 526, as will be described. In addition, the flicker element 561 is positioned in a path of light (schematically represented by arrow 502, shown in FIG. 24) from the light source 530, and the flicker element 561 creates a fluctuating light. The fluctuating light transmitted through the screen 542 is attenuated and a three-dimensional image of flames appears to curve around the profile 527 of the simulated fuel bed 526.

Preferably, the simulated fuel bed 526 includes a simulated fuel portion comprising a plurality of simulated logs 531 positioned on a simulated ember bed portion 533. The simulated fuel bed 526 preferably is formed as described in U.S. Pat. Nos. 6,050,011 and 6,363,636. Each of U.S. Pat. Nos. 6,050,011 and 6,363,636 is hereby incorporated herein by reference.

The screen 542 may conveniently be formed by vacuum-forming (or otherwise forming, in any suitable manner) a sheet of plastic to the desired shape. Preferably, the screen 542 comprises a single sheet of polyethylene having a haze (measured in accordance with ASTM D 1003-0) in excess of 30 percent. The curvature of the curved portion 529 preferably follows the profile 527 of the simulated fuel bed 526 to give the appearance that the image of flames transmitted through the screen 642 is emanating from the simulated fuel bed 626. In addition, the curvature of the curved portion 529, in the horizontal direction along simulated fuel bed 526, preferably tracks, or generally corresponds to. the particular angle at which a simulated log 531 lies on the simulated ember bed portion 533. At a horizontal portion of the simulated fuel bed 526 where no simulated log 531 is located, the screen 542 is locally curved to be closer to the simulated fuel bed 526 so that it appears that the image of flames transmitted through the screen 542 is emanating from the embers between the simulated logs 531 of the simulated fuel bed 526.

The light source 530 can comprise one or more electric light bulbs, halogen lamps, or any other suitable lighting means.

It will be appreciated that various arrangements can be used for the flicker element 561. Preferably, the flicker element 561 is constructed as described in U.S. Pat. No. 6,050,011.

It is also preferred that the flame simulating assembly 510 includes a flame effect element 558, shown in FIG. 24. While various other arrangements can be employed, the flame effect element 568 is preferably in the form described above as element 58′.

In use, the flicker element 561 causes light from the light source 530 to fluctuate or flicker. The fluctuating light is reflected or transmitted from the flicker element 561 to the screen 542, and is transmitted through the screen 542. Also, the fluctuating light transmitted through the screen 542 is thereby attenuated, or modified, so that the transmitted light appears as a three-dimensional image. The image of flames which is transmitted through the curved portion 529 of the screen 542 appears to curl, or curve, around the profile 527 of the simulated fuel bed 526, providing a realistic image of flames. Because of the curvature of the curved portion 529, the three-dimensional image of flames transmitted through the curved portion 52D appears to curve around the simulated fuel bed 526 similarly to flames curing around fuel in a real fire.

As noted above, it is preferred that the flame simulating assembly 510 includes the flame effect element 558, positioned in a path of the fluctuating light (schematically represented by arrow 504, shown in FIG. 24) between the flicker element 561 and the screen 542. The flame effect element 558 configures the fluctuating light so that an image of flames is transmitted through the screen 542.

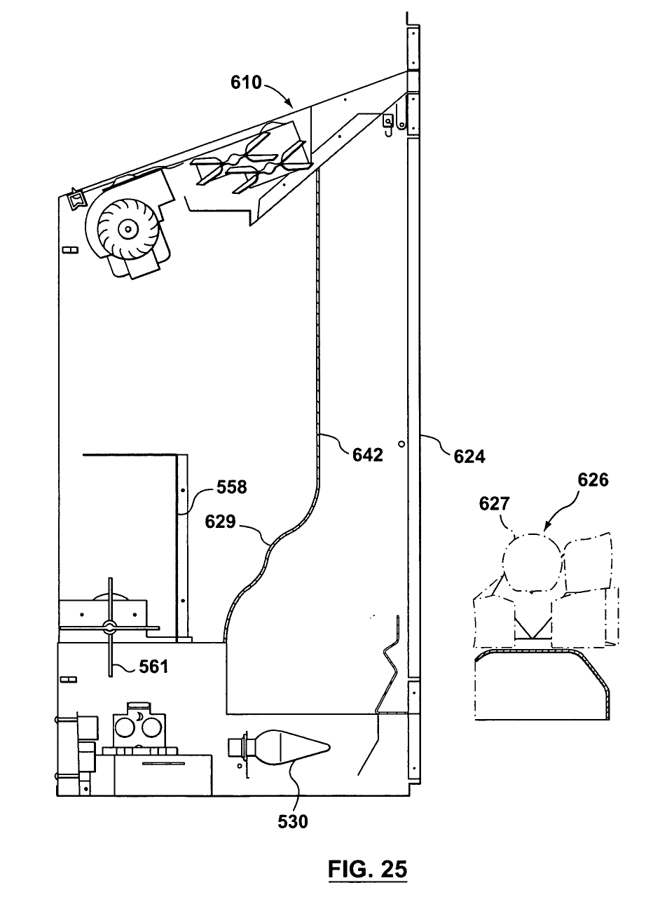

In FIG. 25, another embodiment of the flame simulating assembly 610 is shown in which the flame simulating assembly 610 is adapted for use with a simulated fuel bed 626. The flame simulating assembly 610 includes a screen 642 (FIG. 25). The simulated fuel bed 626 preferably comprises a simulated ember portion (preferably a vacuum-formed plastic assembly, formed and colored to resemble embers forming the base of a real fire) supporting simulated fuel portions (e.g., wooden logs or other suitable materials for simulating combustible fuel in a real fire), as shown in ghost outline in FIG. 25. Alternatively, the simulated fuel bed 626 can include, for example, a grate (not shown) supporting a simulated fuel portion (not shown).

In use, the simulated fuel bed 626 may be positioned adjacent to the screen 642 or disposed outside the flame simulating assembly 610, adjacent to a transparent front panel 624. The simulated fuel bed 626 in any event has a profile 627 viewable by an observer (not shown), and it is preferable that the simulated fuel bed 626 be positioned substantially adjacent to a curved portion 629 of the screen 642. The simulation of flames appears more realistic when the image of flames transmitted through the screen 642 appears to curve around the profile 627 of the simulated fuel bed 626, and this effect is better achieved when the simulated fuel bed 626 and the curved portion 629 of the screen 642 are positioned in close proximity to each other.

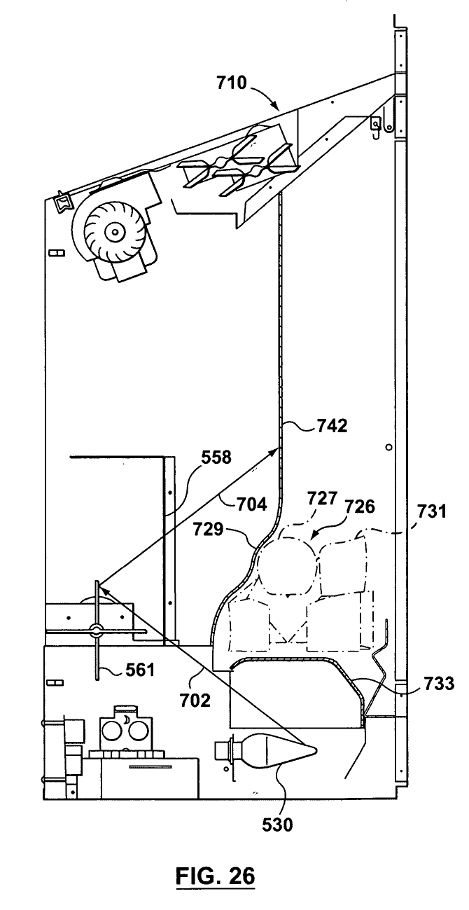

FIG. 26 illustrates another embodiment 710 of the flame simulating assembly of the invention. In this embodiment, the flame simulating assembly 710 is adapted for use with a simulated fuel portion 731, shown in ghost outline in FIG. 26. The flame simulating assembly 710 also includes a simulated ember bed portion 733 (FIG. 26). Preferably, the simulated ember bed portion 733 is vacuum-formed from plastic and colored so as to resemble an ember bed. The simulated ember bed portion 733 is adapted to receive the simulated fuel portion 731 to form a simulated fuel bed 726. The simulated fuel portion 731 preferably are formed to resemble logs of wood (as shown) or, alternatively, lumps of coal (not shown), partially consumed in a fire. It is preferred that the simulated ember bed portion 733 resembles an ember bed for the type of fuel represented by the simulated fuel portion 731.

In the embodiment shown in FIG. 26, the simulated fuel bed 726 has a profile 727 viewable by an observer (not shown). As can be seen in FIG. 26, the flicker element 561 is positioned in a path of light (schematically represented by arrow 702) from the light source 530. In use, the flicker element 561 causes light from the light source 530 to fluctuate or flicker. The fluctuating light is reflected or transmitted from the flicker element 561 to a screen 742. Also, the fluctuating light transmitted through the screen 742 is attenuated, or modified, and the transmitted light appears as a three-dimensional image. Specifically, the image of flames which is transmitted through a curved portion 729 of the screen 742 appears to curve around the profile 727 of the simulated fuel bed 726, providing a realistic image of flames. Because of the curvature of the curved portion 729, the image of flames transmitted through the curved portion 729 appears to be three-dimensional and to curve around the simulated fuel bed 726 similarly to flames curling around fuel in a real fire.

Preferably, the flame simulating assembly 710 includes the flame effect element 558, positioned in a path of the fluctuating light (schematically represented by arrow 704, shown in FIG. 26) between the flicker element 561 and the screen 742. The flame effect element 758 configures the fluctuating light so that an image of flames is transmitted through the screen 742.

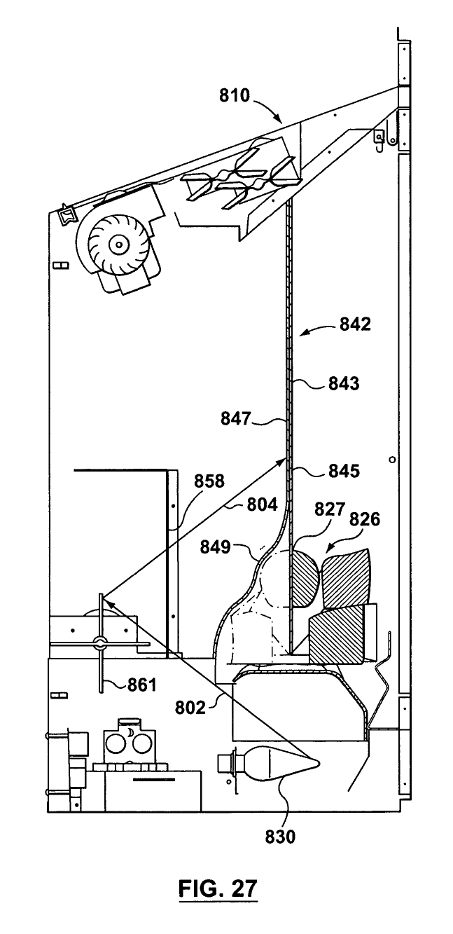

In another embodiment, shown in FIG. 27, the flame simulating assembly 810 includes a screen 842 which comprises a front member 843 disposed behind the simulated fuel bed 826 with a partially reflective front surface 845 for reflecting and transmitting light, and a diffusing member 847, for diffusing and transmitting light, which is disposed behind the front member 843. As can be seen in FIG. 27, the screen 842 is located immediately behind the simulated fuel bed 826 so that the simulated fuel bed 826 is reflected in the partially reflective front surface 845 to give an illusion of depth. Preferably, the simulated fuel bed 826 is formed to resemble one-half—i.e., the front half—of a real fuel bed. An image of the simulated fuel bed 826 (i.e., the front half, appears in the front surface 845, such image providing the appearance of a back half of the simulated fuel bed 826, thereby providing the illusion of depth. Accordingly, the simulated fuel bed 826 has a reflected profile 827 appearing in the partially reflective front surface 845 and viewable by an observer (not shown) who is observing the flame simulating assembly 810 from the front. Because of the combination of the simulated fuel bed 826 and the partially reflective front surface 845, the image of flames which is transmitted through the screen 842 appears to arise in the center of the simulated fuel bed 826.

Preferably, the diffusing member 847 includes a curved portion 849 which is curved in a vertical direction and in a horizontal direction to correspond to the reflected profile 827 of the simulated fuel bed 826, and positioned behind the front member 843. The curvature in the vertical direction of the curved portion 849 of the diffusing member 847 preferably follows the reflected profile 827 of the simulated fuel bed 826 in the partially reflective front surface 845, to give the appearance that the image of flames is emanating from between the simulated fuel bed 826 and the image of the simulated fuel bed 826 reflected in the partially reflective front surface 845. Also, the curvature of the curved portion 849 in the horizontal direction preferably tracks the particular angle at which a simulated log appears to lie in the simulated fuel bed 826 and follows the apparent location of the log in the front surface 845. At a horizontal position on the simulated fuel bed 826 where no simulated log is located, the curved portion 849 is locally curved to be adjacent the front member 843 to provide the appearance that the image of flames is emanating from the embers between the logs of the simulated fuel bed 826.

Preferably, an upper part of the curved portion 849 is generally curved toward the front member 843. This curvature tends to create the illusion to the observer that the image of flames transmitted through the screen 842 is licking over the simulated fuel included in the simulated fuel bed 826.

The flame simulating assembly 810 also includes a flicker element 861 positioned in a path of light (schematically represented by arrow 802, shown in FIG. 27) from a light source 830, for creating the fluctuating light. Accordingly, the fluctuating light transmitted through the screen 842 is attenuated, or modified, upon transmission therethrough, and the three-dimensional image of flames resulting appears to curve around the reflected profile 827 of the simulated fuel bed 826.

It is also preferred that the flame simulating assembly 810 includes a flame effect element 858 positioned in a path of the fluctuating light (schematically represented by arrow 804) between the flicker element 861 and the diffusing member 847. Similar to the flame effect elements in the other embodiments described herein, the flame effect element 858 configures the fluctuating light so that a fluctuating image of flames is transmitted through the screen 842.

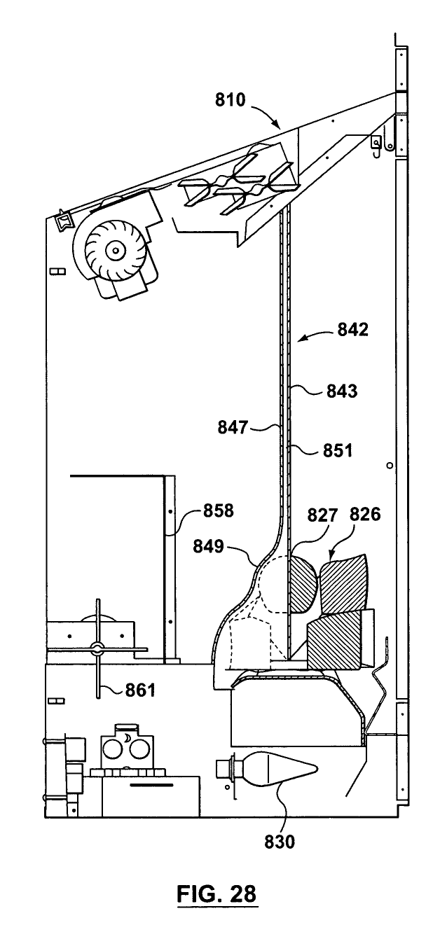

As shown in FIG. 27, except for the curved portion 849 and the portion of the front member 843 corresponding thereto, the diffusing member 847 and the front member 843 are preferably positioned substantially adjacent to each other. However, as shown in FIG. 28, the diffusing member 847 and the front member 843 are positionable spaced apart from each other a predetermined distance so that a gap 851 is disposed between the diffusing member 847 and the front member 843 above the curved portion 849. Due to the gap 851, the image of flames transmitted through the screen 842 is further attenuated or modified.

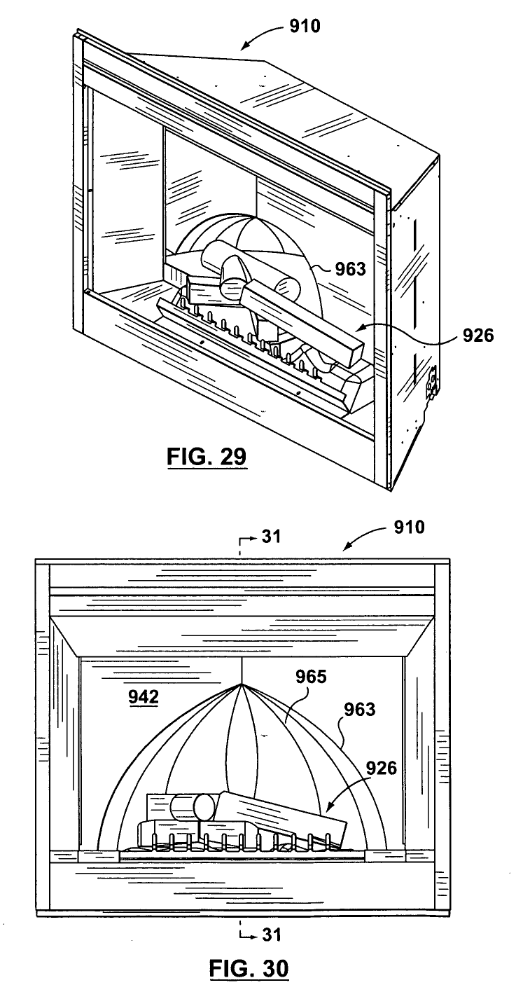

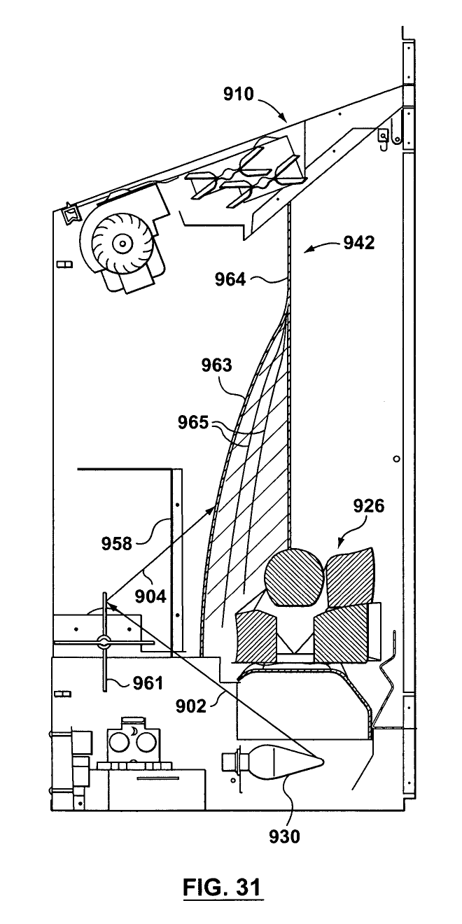

Another embodiment of the flame simulating assembly 910 is shown in FIGS. 29-31. In the flame simulating assembly 910, a screen 942 includes a conoid concavity 963 positioned substantially adjacent to the simulated fuel bed 926. Preferably, and as can be seen in FIGS. 30 and 31, the conoid concavity 963 extends substantially above the simulated fuel bed 926. An upper portion 964 of the screen 942 extends above the conoid concavity 963. The upper portion 964 is preferably substantially planar, as shown in FIG. 31.

The fluctuating light transmitted through the conoid concavity 963 of the screen 942 is attenuated, or modified, and a three-dimensional image of flames appears to curve around me simulated fuel bed 926 in the conoid concavity 963. The image of flames appears to curve, or curl, upon transmission of the image of flames through the conoid concavity 963 and the upper portion 964. However. it will be appreciated that the image of flames can also appear to curve around the simulated fuel bed 926 (or part or parts thereof) upon transmission of the image of flames through the conoid concavity 963 only.

It is preferred that the conoid concavity 963 is generally fluted, i.e., including a plurality of spaced apart grooves 965 on the inner surface of the conoid concavity 963, the grooves 965 curving inwardly, from bottom to top, for further attenuating (or modifying) the fluctuating light transmitted through the conoid concavity 963. The grooves 965 are preferably configured so that the image of flames transmitted through the conoid concavity 963 further realistically simulates the random fluctuations of real flames, e.g., sometimes curling or curving around the fuel.

In the preferred embodiment, and as shown in FIG. 31, the simulated fuel bed 926 is at least partially positioned within the conoid concavity 963. The flame simulating assembly 910 preferably includes a flicker element 961 positioned in a path of light (schematically represented by arrow 902) from a light source 930, for creating a fluctuating light. In addition, the flame simulating assembly 910 preferably includes a flame effect element 958, positioned in a path of fluctuating light (schematically represented by arrow 904) between the flicker element 961 and the screen 942. The flame effect element 958 configures the fluctuating light to form the image of flames which is transmitted through the screen 942.

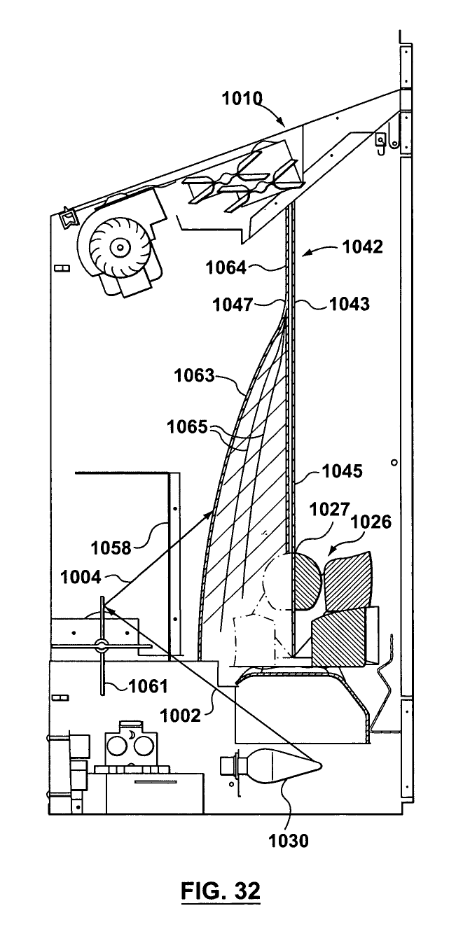

In yet another embodiment, shown in FIG. 32, a flame simulating assembly 1010 includes a screen 1042 comprising a front member 1043 disposed behind the simulated fuel bed 1026 and a diffusing member 1047 disposed behind the front member 1043. The front member 1043 has a partially reflective front surface 1045 positioned adjacent to the simulated fuel bed 1026. The screen 1042 is located immediately behind the simulated fuel bed 1026 so that the simulated fuel bed 1026 is reflected in the partially reflective front surface 1045 to give the illusion of depth. As described, the simulated fuel bed 1026 is formed to resemble one-half of a real fuel bed. An image of the simulated fuel bed 1026 appears in the partially reflective front surface 1045. to simulate the other half of the fuel bed. Accordingly. the simulated fuel bed 1026 has a profile 1027 reflected in the partially reflective front surface 1045 and viewable by an observer (not shown). The diffusing member 1047 includes a conoid concavity 1063 positioned substantially adjacent to the image of the simulated fuel bed 1026 appearing on the partially reflective front surface 1047. The diffusing member 1047 also includes a substantially planar top portion 1064 located above the conoid concavity 1063. The fluctuating light transmitted through the screen 1042 is attenuated and a three-dimensional image of flames appears to curve around the simulated fuel bed 1026 in the conoid concavity 1063.

Preferably, the conoid concavity 1063 is generally fluted, i.e., including a plurality of spaced apart grooves 1065 on the inner surface of the conoid concavity 1063, the grooves 1065 curving inwardly, from bottom to top, for further attenuating (or modifying) the fluctuating light transmitted through the conoid concavity 1063. The grooves 1065 are preferably configured so that the image of flames transmitted through the conoid concavity 1063 further simulates random fluctuations of real flames.

As can be seen in FIG. 32, the flame simulating assembly 1010 includes a flicker element 1061. The flicker element 1061 is positioned in a path of light (schematically represented by arrow 1002) from the light source 1030, and the flicker element 1061 creates a fluctuating light. The fluctuating light resulting from the flicker element 1061 is transmitted through the screen 1042. Preferably, the flame simulating assembly 1010 also includes a flame effect element 1058 for configuring the fluctuating light to form the image of flames transmitted through the screen 1042. The flame effect element 1058 is positioned in a path of the fluctuating light (schematically represented by arrow 1004) between the flicker element 1061 and the screen 1042.

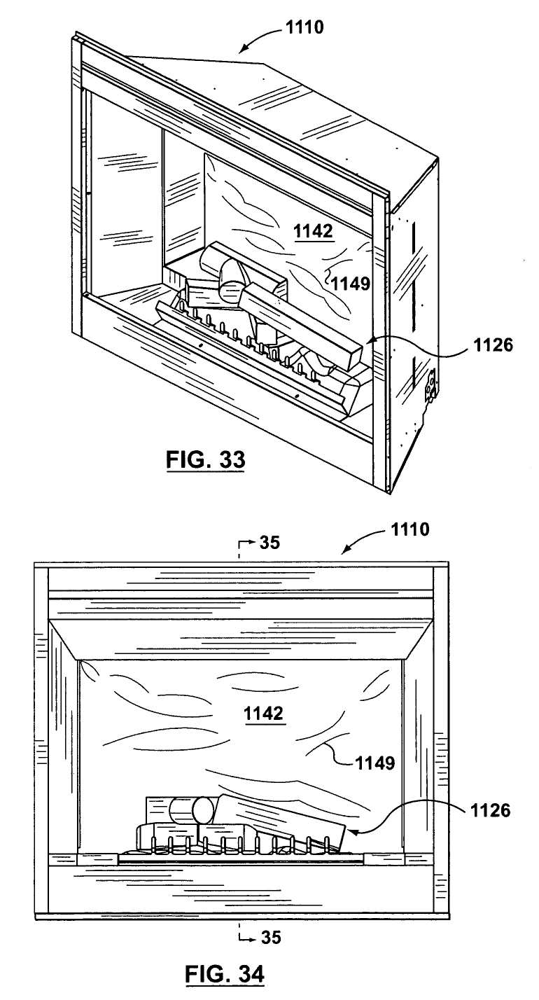

In yet another embodiment. as shown in FIGS. 33-35. a flame simulating assembly 1110 includes a screen 1142 having a front surface 1145 disposed behind the simulated fuel bed 1126 for diffusing and transmitting light. The screen 1142 also has a back surface 1167 which is preferably curved in a vertical direction and in a horizontal direction in a manner selected so as to further simulate the random fluctuations of real flames. Preferably, and as shown in FIGS. 33-35, the screen includes a plurality of curved portions 1149 which are randomly and irregularly positioned in the screen, randomly spaced apart from each other. The curved portions 1149 can be of different sizes, and each can be curved to a different extent. Alternatively, the curved portions 1149 could be of substantially uniform size and shape (or at least partially uniform), and they could also be spaced apart on a non-random basis. Each curved portion 1149 is spaced apart from adjacent curved portions 1149 by at least a minimum predetermined distance (whether random or non-random), to provide a more realistic image of flames. The fluctuating light transmitted through the curved portions 1149 of the screen 1142 is attenuated, or modified. and one or more three-dimensional images of flames appears through the screen 1142.

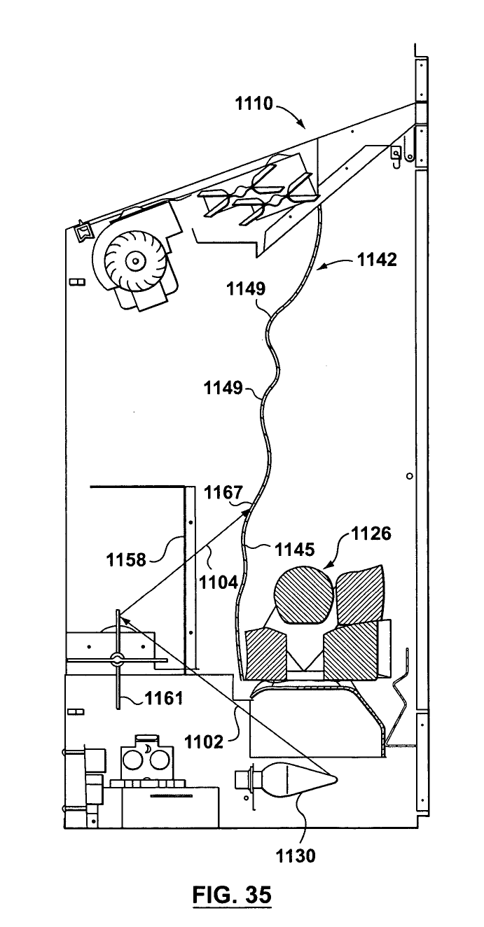

The flame simulating assembly 1110 also includes a light source 1130 and a flicker element 1161 positioned in a path of light (schematically represented by arrow 1102, shown in FIG. 35) from the light source 1130, for creating fluctuating light. The flicker element 1161 is positioned in the path of light between the light source 1130 and the back surface 1167 of the screen 1142. Fluctuating light from the flicker element 1161 is transmitted through the screen 1142 and is attenuated, or modified, upon transmission through the curved portions 1149. The result is that those portions of the image of flames which are transmitted through the curved portions 1149 are given a three-dimensional appearance, simulating variations in the appearance of flames in a real fire.

It is also preferred that the flame simulating assembly 1110 includes a flame effect element 1158 positioned in a path of fluctuating light (schematically represented by arrow 1104, shown in FIG. 35) between the flicker element 1161 and the back surface 1167. The flame effect element 1158 configures the fluctuating light to form the image of flames which is transmitted to the back surface 1167 of the screen 1142.

It is to be understood that what has been described is a preferred embodiment to the invention. The invention nonetheless is susceptible to certain changes and alternative embodiments fully comprehended by the spirit of the invention as described above, and the scope of the claims set out below.

We claim:

1. A flame simulating assembly for providing a three-dimensional image of flames formed by fluctuating light, the flame simulating assembly having:
a simulated fuel bed;
a light source;
a screen disposed behind the simulated fuel bed for diffusing and transmitting light, the screen including a conoid concavity positioned adjacent to the simulated fuel bed;
a flicker element for creating the fluctuating light, the flicker element being positioned in a path of light between the light source and the screen; and
said fluctuating light being transmitted through the screen and attenuated to form the three-dimensional image of flames.

2. A flame simulating assembly as claimed in claim 1 in which the conoid concavity extends above the simulated fuel bed, such that the three-dimensional image of flames appears to curve around the simulated fuel bed.

3. A flame simulating assembly as claimed in claim 1 in which the simulated fuel bed is at least partially positioned in the conoid concavity.

4. A flame simulating assembly as claimed in claim 1 in which the conoid concavity includes a plurality of grooves, for further attenuating the fluctuating light transmitted through the conoid concavity, to form the three-dimensional image of flames.

5. A flame simulating assembly as claimed in claim 1 additionally including a flame effect element positioned in a path of the fluctuating light between the flicker element and the screen, to configure the fluctuating light to form the image of flames.

6. A flame simulating assembly for providing a three-dimensional image of flames formed by fluctuating light, the flame simulating assembly having:
a simulated fuel bed;
a light source;
a screen including a front member disposed behind the simulated fuel bed and a diffusing member disposed behind the front member for diffusing and transmitting light, the front member having a partially reflective front surface for reflecting and transmitting light and the diffusing member having a conoid concavity positioned proximal to the simulated fuel bed; and
a flicker element for creating the fluctuating light, the flicker element being positioned in a path of light between the light source and the diffusing member; and
said fluctuating light being transmitted through the screen and attenuated to form a three-dimensional image of flames which appears to curve around the simulated fuel bed.

7. A flame simulating assembly as claimed in claim 6 in which the diffusing member is spaced apart from the front member, such that the fluctuating light transmitted through the screen is attenuated to form the three-dimensional image of flames.

8. A flame simulated assembly as claimed in claim 6 in which the conoid concavity extends substantially above the simulated fuel bed.

9. A flame simulating assembly as claimed in claim 6 in which the conoid concavity includes a plurality of grooves, for attenuating the fluctuating light transmitted through the conoid concavity to form the three-dimensional image of flames.

10. A flame simulating assembly as claimed in claim 6 additionally including a flame effect element positioned in a path of the fluctuating light between the flicker element and the diffusing member, to configure the fluctuating light to form the image of flames.

11. A flame simulating assembly for providing an image of flames, the flame simulating assembly having:
a simulated fuel bed defining a profile thereof;
a light source;
a screen positioned behind the simulated fuel bed for transmitting and diffusing light, the screen including a plurality of curved portions, each said curved portion being adapted to attenuate the image of flames upon transmission thereof through the screen to give at least a portion of the image of flames a three-dimensional appearance; and
a flicker element for causing light from the light source to fluctuate to form the image of flames, the flicker element being positioned between the light source and the screen.

12. A flame simulating assembly as claimed in claim 11 in which said curved portions are randomly positioned in the screen.

13. A flame simulating assembly as claimed in claim 12 in which said curved portions are spaced apart from each other, each by at least a minimum predetermined distance.

14. A flame simulating assembly as claimed in claim 11 additionally including a flame effect element for configuring light from the light source to form the image of flames, the flame effect element being positioned in a path of light from the light source between the flicker element and the screen.
